(19) United States
(12) Patent Application Publication
(10) Pub. No.: US 2012/0273456 A1
(43) Pub. Date: Nov. 1, 2012

(54) MAGNETIC RECORDING MEDIUM AND METHOD FOR MANUFACTURING THE SAME

(75) Inventors: Masatoshi Sakurai, Tokyo (JP); Makoto Asakura, Tokyo (JP)

(73) Assignee: Kabushiki Kaisha Toshiba, Tokyo (JP)

(21) Appl. No.: 13/545,939

(22) Filed: Jul. 10, 2012

Related U.S. Application Data
(62) Division of application No. 12/125,251, filed on May 22, 2008.

(30) Foreign Application Priority Data
May 23, 2007 (JP) 2007-136890

(51) Int. Cl. G11B 5/84

(52) U.S. Cl. 216/22

(57) ABSTRACT

According to one embodiment, a magnetic recording medium includes recording areas forming protrusions corresponding to servo signals and recording tracks and includes a crystalline magnetic layer, and non-recording areas comprising an amorphous damaged layer left in bottoms of recesses between the recording areas.

### CROSS-REFERENCE TO RELATED APPLICATIONS

This application is a divisional of U.S. patent application Ser. No. 12/125,251, filed May 22, 2008 which is based upon and claims the benefit of priority from Japanese Patent Application No. 2007-136890, filed May 23, 2007, the entire contents of which are incorporated herein by reference.

### BACKGROUND

1. Field

One embodiment of the present invention relates to a discrete track recording type magnetic recording medium and a method for manufacturing the same.

2. Description of the Related Art

Recently, an evident problem with magnetic recording media incorporated into hard disk drives (HDD) is that interference between adjacent tracks prevents track density from being improved.

To solve this problem, a proposal has been made of a discrete track recording type magnetic recording medium (DTR medium) having recording tracks physically separated from one another formed by processing a magnetic recording layer. The DTR medium enables the inhibition of a side erase phenomenon in which information in an adjacent track is erased during write operation and a side read phenomenon in which information in an adjacent track is read out during read operation, allowing an increase in track density. Therefore, the DTR medium is expected as a magnetic recording medium that can achieve a high recording density.

The following types are known for the structure of the discrete track medium:

1. A medium in which the magnetic layer in non-recording areas is etched in the thickness direction thereof to reach the underlayer, and the recesses in the non-recording areas are filled with an embedding layer made of non-magnetic material. The medium with this structure is called a “totally-etched type”.

2. A medium in which the magnetic layer in non-recording areas is etched partially in the thickness direction thereof, and the magnetic layer is left in the bottoms of the recesses in the non-recording areas. The medium with this structure is called a “partially-etched type”. See, for example, U.S. Pat. No. 6,999,279.

3. A medium in which the magnetic layer in non-recording areas is modified into an amorphous state, for example. The medium with this structure is called a “modified type”. See, for example, Jpn. Pat. Appln. KOKAI Publication No. 2006-309841.

However, these three types of DTR media have problems as follows.

1. In the totally-etched type, since the magnetic layer in the non-recording areas is etched totally, the step between the recording areas and non-recording areas is very high. On the other hand, to obtain flying stability of a read/write head, it is necessary to flatten the surface of the medium by filling the recesses with a non-magnetic layer. However, since the step of the recesses is very high, it takes time to fill the recesses, making it difficult to flatten the medium.

2. In the partially-etched type, since the step between the recording areas and non-recording areas is small, there is no problem in flying stability of a read/write head. However, the magnetic layer is left not only in the recording areas but also in the non-recording areas, the servo signal intensity from the DC demagnetized servo regions is relatively weak, making it hard to position the read/write head.

3. In the modified type, since the magnetic layer of the non-recording areas is modified by ion implantation without being etched, there is no step on the surface of the medium, bringing about good flying stability of a read/write head. However, it is hard to change the interface between the recording areas and non-recording areas steeply by ion implantation, and thus the signal-to-noise ratio is lowered in read operation, deteriorating the bit error rate.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic plan view of a magnetic recording medium according to the present invention;

FIG. 2 is a schematic diagram of a servo region and a data region;

FIG. 3 is plan view showing a pattern of the servo region and the data region;

FIG. 4 is a cross-sectional view of a magnetic recording medium according to a first embodiment of the present invention;

FIG. 5 is a cross-sectional view of a magnetic recording medium according to a second embodiment of the present invention;

FIG. 6 is a cross-sectional view of a magnetic recording medium according to a third embodiment of the present invention;

FIG. 7 is a cross-sectional view of a magnetic recording medium according to a fourth embodiment of the present invention;

FIGS. 8A to 8F are cross-sectional views showing a method for manufacturing a magnetic recording medium according to the present invention;

FIGS. 9A to 9C are cross-sectional views showing another method for manufacturing a magnetic recording medium according to the present invention; and

FIG. 10 is a block diagram of a magnetic recording apparatus according to the present invention.

### DETAILED DESCRIPTION

Various embodiments according to the invention will be described hereinafter with reference to the accompanying drawings. In general, according to an aspect of the present invention, there is provided a magnetic recording medium comprising: recording areas forming protrusions corresponding to servo signals and recording tracks and comprising a crystalline magnetic layer; and non-recording areas comprising an amorphous damaged layer left in bottoms of recesses between the recording areas.

According to another aspect of the present invention, there is provided a method for manufacturing a magnetic recording medium comprising: depositing a crystalline magnetic layer on a substrate; selectively etching a part of the crystalline magnetic layer corresponding to non-recording areas to form recesses in the non-recording areas with a part of the crystalline magnetic layer left in bottoms of the recesses and to form protruded recording areas; and causing damage to the crystalline magnetic layer left in the bottoms of the recesses in the non-recording areas to form an amorphous damaged layer.

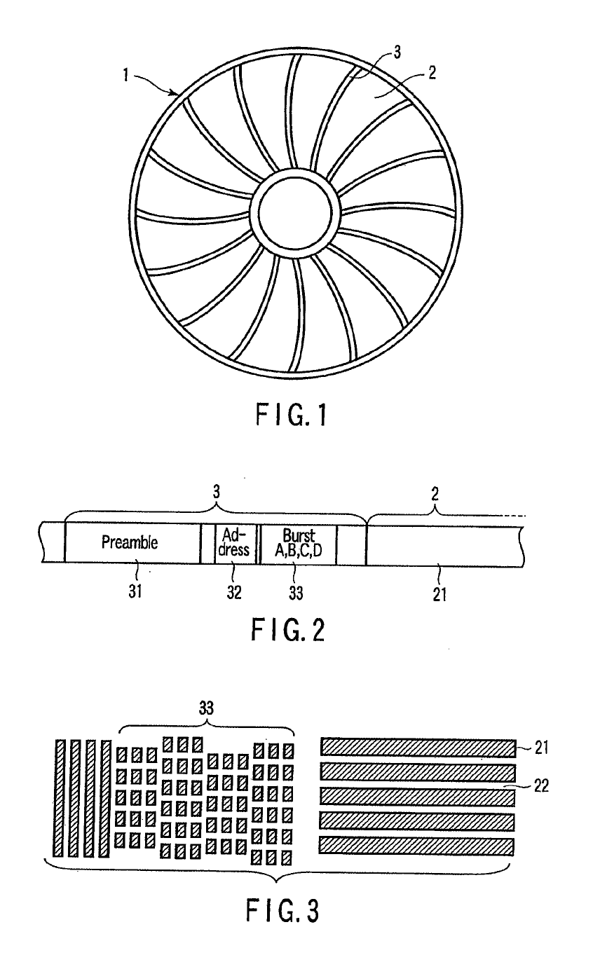

FIG. 1 shows a schematic plan view of a magnetic recording medium (DTR medium) 1 according to the present invention. In FIG. 1, data regions 2 and servo regions 3 are shown. The data region 2 is a region in which user data is recorded. The shape of the servo region 3 on the medium surface is an arc shape corresponding to the locus of a head slider accessing the magnetic recording medium. The servo region 3 is formed to have a circumferential length increasing as a radial position in the servo region 3 approaches the outer periphery of the recording medium. FIG. 1 shows 15 servo regions 3, but not less than 100 servo regions 3 are formed in an actual medium.

FIG. 2 is a schematic diagram of the servo region and the data region. FIG. 3 shows patterns of recording areas and non-recording areas in the servo region and data region. As shown in these diagrams, the data regions 2 are divided into sectors in the circumferential direction by the servo regions 3.

In the data region 2, recording tracks (discrete tracks) 21 are formed as recording areas forming protrusions at specified track pitch Tp. User data is recorded in the recording tracks 21. Adjacent recording tracks 21 in the cross-track direction are separated from each other by non-recording areas 22.

The servo region 3 includes a preamble section 31, an address section 32, and a burst section 33. Patterns of recording areas and non-recording areas which provide servo signals are formed in the preamble section 31, address section 32, and burst section 33 in the servo region 3. These sections have functions described below.

The preamble section 31 allows execution of a PLL process of synchronizing a servo signal read clock when a time difference results from rotational decentering of the medium and an AGC process of appropriately maintaining a signal read width. The preamble section 31 has magnetic patterns which constitute protrusions extending continuously in a radial direction without being separated so as to form substantial circular arcs and which are repeatedly formed in a circumferential direction.

In the address section 32, servo signal recognition codes called servo marks, sector information, cylinder information, and the like are formed at the same pitch as the circumferential pitch in the preamble section 31 using Manchester codes. In particular, the cylinder information has patterns in which the information varies with the servo track. Thus, to reduce the adverse effect of address read errors during a seek operation, the cylinder information is converted into Gray codes that minimize the difference in information between the adjacent tracks and the Gray codes are then converted into Manchester codes for recording.

The burst section 33 is an off-track detecting area required to detect the off-track amount of a cylinder address with respect to an on-track state. Four types of marks (called an A burst, B burst, C burst, and D burst) are formed in the burst section 33 by shifting a pattern phase in the radial direction. In each of the bursts, marks are arranged at the same pitch as that in the preamble section in the circumferential direction. The radial period of each burst is proportional to a period at which an address pattern varies, in other words, a servo track period. About 10 periods of each burst are formed in the circumferential direction. The bursts are repeatedly formed in the radial direction at a pitch double the servo track period.

The marks in the burst section 33 are designed to be rectangular, or in a strict sense, to be parallelograms taking a skew angle during head access into account. However, the marks are slightly rounded depending on the processing accuracy of a stamper or processing performance such as transfer formation. The mark may be formed either as non-recording area or as recording area. The principle of position detection in the burst section 33 will not be described in detail, but in short the off-track amount is calculated by arithmetically processing the average amplitude value of read signals from each of the A, B, C, and D bursts.

As mentioned above, the discrete track recording medium (DTR medium) has servo regions and data regions. The servo region is entirely DC demagnetized in a direction perpendicular to the medium plane, and all recording areas in the servo region are magnetized in one direction. The magnetic recording apparatus, when positioning the read/write head, the patterns of the output from the recording areas magnetized in one direction in the servo region and the output from the non-recording areas between the recording areas are read. Accordingly, in order to perform accurate positioning in the servo region, the signal intensity ratio between the recording areas and non-recording areas of the servo region is required to be high.

In conventional DTR media, in order to increase the signal intensity ratio between the recording areas and non-recording areas of the servo region, the totally-etched type in which the magnetic layer is totally etched from the non-recording area, or the modified type is preferred. The partially-etched type has a problem of deteriorated positioning characteristics because of low signal intensity ratio between the recording areas and non-recording areas. In the totally etched type, however, since the recesses left after processing of the magnetic material are deep, it is hard to fill the recesses and flatten the surface, and the flying stability of the read/write head may be affected. Hence, the modified type is advantageous from the viewpoint of the positioning characteristics and the head flying stability.

In the conventional modified type DTR medium, a method of modifying the magnetic layer by ion implantation is well known. It is, however, hard to assure the straightforwardness of implanted ions, and thus it is difficult to assure steepness of interface between the recording area and non-recording area, that is, between a magnetic layer and a modified magnetic layer. Further, since implanted ions are diffused by heat or chemical treatment after ion implantation, the steepness of interface between the recording area and non-recording area is impaired. When signals are read out, the surface of recording areas are close to the read head, and thus there is a large effect of the signals from the magnetic layer on the surface. In particular, since the frequency of the magnetic signals recorded in the recording area is higher than the frequency of the positioning signals in the servo region, the effect of the surface of the magnetic layer is significant. Accordingly, when the steepness of interface between the recording area and non-recording area is poor, noise corresponding to fluctuation of the interface of the recording track is generated in readout operation.

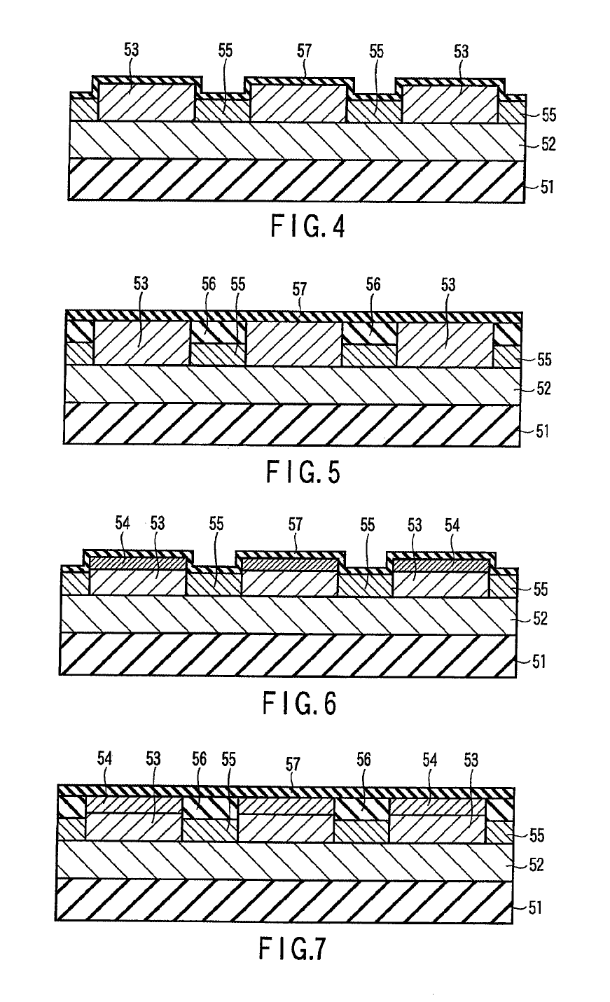

The DTR medium of the present invention is to solve these problems. FIG. 4 shows a cross-sectional view of a DTR medium according to a first embodiment of the present invention. In FIG. 4, a soft magnetic underlayer 52 is formed on a substrate 51. On the soft magnetic underlayer 52, a crystalline magnetic layer 53 processed into protrusions corresponding to servo signals and recording tracks are formed as recording areas. An amorphous damaged layer 55 is formed in non-recording areas between the recording areas. A protective layer 57 is formed on the surface thereof.

In the first embodiment, a part of the crystalline magnetic layer in the non-recording areas is etched so as to form a step between the recording areas and non-recording areas. Then, the crystalline magnetic layer left in the recesses is damaged to make it amorphous, thereby entirely modifying the crystalline magnetic layer left in the non-recording areas to an amorphous damaged layer. By using etching process, as compared with the conventional modifying process, a steep interface can be formed in the crystalline magnetic layer of the recording area, because any diffusion between the recording area (magnetic layer) and the non-recording area (etched area) occurs. Accordingly, even if the crystalline magnetic layer left in the recesses is entirely modified, a steep interface in the recording area can be maintained, and noise generation in readout operation can be suppressed. Further, since an amorphous damaged layer is formed in the non-recording areas, after the entire medium is DC-magnetized, the magnetic signals sensed by the read head from the non-recording area is low, and a sufficient signal intensity ratio between the recording area and non-recording area is obtained in the servo region. As a result, the read/write head can be positioned accurately. Besides, since an amorphous damaged layer is formed in the non-recording areas, the depth of the step on the surface is not so deep comparing to the “totally-etched type”. Therefore, the medium causes little problem in flying stability of the read/write head comparing to the “totally-etched type”.

FIG. 5 shows a cross-sectional view of a DTR medium according to a second embodiment of the present invention. In FIG. 5, a soft magnetic underlayer 52 is formed on a substrate 51. On the soft magnetic underlayer 52, a crystalline magnetic layer 53 processed into protrusions corresponding to servo signals and recording tracks are formed as recording areas. An amorphous damaged layer 55 and a nonmagnetic embedding layer 56 are stacked in non-recording areas between the recording areas. A protective layer 57 is formed on the surface thereof.

In the second embodiment, the surface flatness can be improved by filling the recesses on the amorphous damaged layer 55 with the nonmagnetic embedding layer 56. As a result, the flying stability of the read/write head can be more improved than in the first embodiment.

In the present invention, by forming the recording areas with a two-layer structure of crystalline magnetic layer and top coat layer, and etching the crystalline magnetic layer of the non-recording areas by more than the thickness of the top coat layer in etching process, the surface of the amorphous damaged layer may be set at a deeper position than the bottom of the top coat layer (or the surface of the crystalline magnetic layer).

FIG. 6 shows a cross-sectional view of a DTR medium according to a third embodiment of the present invention. In FIG. 6, a soft magnetic underlayer 52 is formed on a substrate 51. On the soft magnetic underlayer 52, a crystalline magnetic layer 53 processed into protrusions corresponding to servo signals and recording tracks and top coat layers 54 are stacked as recording areas. An amorphous damaged layer 55 is present in non-recording areas between the recording areas. A protective layer 57 is formed on the surface thereof. The surface of the amorphous damaged layer 55 of the non-recording areas is formed at a deeper position than the thickness of the top coat layer 54, and the top coat layer 54 is separated by the recesses in the non-recording areas.

FIG. 7 shows a cross-sectional view of a DTR medium according to a fourth embodiment of the present invention. As shown in FIG. 7, a nonmagnetic embedding layer 56 may be stacked on an amorphous damaged layer 55 in the recesses, and the medium surface may be flattened. The embedding material and the filling method are the same as in the second embodiment shown in FIG. 5.

The top coat layer 54 is easily magnetized in recording operation, and the magnetized top coat layer 54 functions to assist magnetization of the crystalline magnetic layer 53. Hence, the shape of the top coat layer affects to the magnetic recording pattern, the magnetic interface of the top coat layer 54 is preferred to be steep. In the third embodiment, since the top coat layer 54 is separated by etching, the interface shape of recorded magnetization can be made steep without any chemical diffusion. Since the crystalline magnetic layer 53 in the lower layer is adjacent to the amorphous damaged layer 55, the interface shape is not necessarily steep. If the top coat layer 55 is separated by etching and has a steep interface, the magnetization pattern of the crystalline magnetic layer 53 beneath the top coat layer 54 comes to have a steep interface shape. In the third embodiment, the surface of the amorphous damaged layer 55 in the non-recording areas is at a position deeper than the thickness of the top coat layer 54. Hence, the surface of the crystalline magnetic layer 53 in the recording areas is higher than the surface of the amorphous damaged layer 55 in the non-recording areas, so that the signal quality is improved in a portion closer in distance from the read head in readout operation.

On the other hand, since the patterns of the servo region are formed at a lower frequency than the signal frequency to be recorded in the recording areas, magnetization of the entire magnetic layer is important. In the DTR medium of the present invention, since a modified amorphous damaged layer is formed in the non-recording areas, a signal contrast corresponding to the thickness of the magnetic layer in the recording areas can be obtained. The interface between the amorphous damaged layer in the non-recording area and the crystalline magnetic layer in the recording area may fluctuated due to modifying treatment, but since the servo positioning signals are lower in frequency and higher in wavelength than the signals in the recording area, the effect of interface fluctuation due to modifying treatment may be smaller as compared with the recording area.

That is, in the recording areas, the crystalline magnetic layer has a steeper interface corresponding to the step formed between the recording area and non-recording area, and hence contributes to reduction of noise in readout operation. Further, in the servo region, the amorphous damaged layer in the non-recording areas can sufficiently ensure the intensity of the positioning signals in a low frequency.

In the manufacturing process of the DTR medium, patterns are formed at the same time in servo regions and data regions by imprinting. Accordingly, as in the DTR medium of the present invention, it is effective to employ a structure having a magnetic crystalline layer of steep interface in recording areas and having an amorphous damaged layer in non-recording areas. This effect is not realized in the partially-etched type in which the crystalline magnetic layer is left without modified in the non-recording areas, or in the modified type in which the entire non-recording area is made amorphous. In the totally-etched type, if filling and flattening are performed successfully, it is possible to suppress read signal noise or positioning signal noise in servo regions, but actually it is difficult to perform filling and flattening successfully.

The top coat layer 54 is desired to satisfy any one of the characteristics of stronger exchange coupling between crystal grains, lower magnetic anisotropic constant, and smaller saturation magnetization, as compared with the crystalline magnetic layer 53 in the lower layer. When the top coat layer 54 has such characteristics, it is easier to magnetize the top coat layer 54 by the recording head as compared with the crystalline magnetic layer 53, and it is easier to assist magnetization of the crystalline magnetic layer 53 by the magnetized top coat layer 54 in recording operation.

For example, when the crystalline magnetic layer 53 containing an oxide for separating the magnetic crystal grains is used, in the top coat layer 54, by setting the oxide content lower by 10% or more than the crystalline magnetic layer, the exchange coupling between grains can be reinforced. To set the magnetic anisotropic constant of the top coat layer lower than that of the crystalline magnetic layer, the top coat layer should be higher in Cr content by 10% or more and lower in Pt content by 10% or more than the crystalline magnetic layer mainly composed of CoCrPt alloy. To set the saturation magnetization of the top coat layer lower than that of the crystalline magnetic layer, for example, the top coat layer should be higher in Cr content by 10% or more than the crystalline magnetic layer.

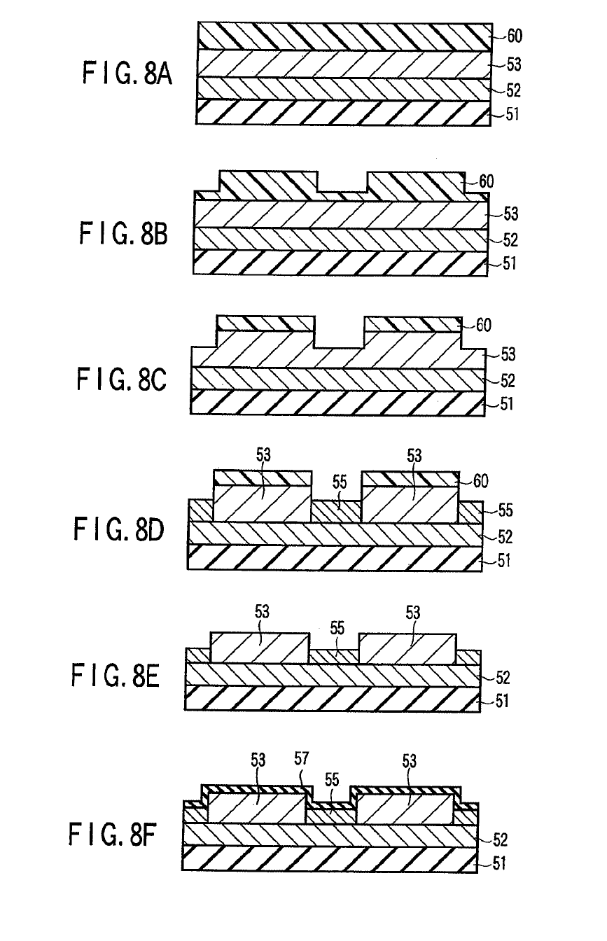

Referring now to FIGS. 8A to 8F, a method for manufacturing a magnetic recording medium (DTR medium) according to the present invention will be described below. In the diagrams, only one side of the substrate is processed, but actually both sides of the substrate are processed.

As shown in FIG. 8A, a soft magnetic underlayer 52, and a crystalline magnetic layer 53 are formed on a substrate 51, and a resist 60 is applied thereto. A top coat layer may be provided on the crystalline magnetic layer 53.

The substrate 51 may be any one of glass substrate, Al-based alloy substrate, ceramic substrate, carbon substrate, Si single crystal substrate having an oxide surface, and these substrates plated with NiP or the like.

The soft magnetic underlayer 52 is formed of a material containing Fe, Ni, or Co. Specific examples include FeCo-based alloy such as FeCo or FeCoV, FeNi-based alloy such as FeNi, FeNiMo, FeNiCr or FeNiSi, FeAl-based alloy and FeSi-based alloy such as FeAl, FeAlSi, FeAlSiCr, FeAlSiTiRu or FeAlO, FeTa-based alloy such as FeTa, FeTaC or FeTaN, and FeZr-based alloy such as FeZrN.

The crystalline magnetic layer 53 is formed of, for example, a magnetic material containing CrCrPt alloy and an oxide, and having a perpendicular magnetic anisotropy. The oxide is preferably silicon oxide or titanium oxide.

The amorphous damaged layer 55 is formed of the crystalline magnetic layer 53 made amorphous by the treatment during medium manufacturing process. The amorphous damaged layer is, as compared with the crystalline magnetic layer, nonmagnetic in characteristics being free from remanent magnetization. As compared with the crystalline magnetic layer which is crystalline in structure, the amorphous damaged layer is nearly the same in composition as the crystalline magnetic layer, but is disturbed in the crystal lattice structure. The composition of the amorphous damaged layer may contain oxygen, argon, carbon, or fluorine possibly mixed in when damaging the crystalline magnetic layer. The amorphous damaged layer and the crystalline magnetic layer can be suitably discriminated by observation with a sectional TEM. That is, a crystal lattice is observed in the sectional TEM image of the crystalline magnetic layer, but a crystal lattice is not observed or very few in the amorphous damaged layer. Further, due to the above inclusion smaller in atomic weight than cobalt and change in density in the course of conversion to the amorphous state, the amorphous damaged layer portion looks brighter than the crystalline magnetic layer portion in the sectional TEM image. Whether the amorphous damaged layer is present may be judged by observation of lattice image with a sectional TEM, or by comparison of contrast of the corresponding portions.

In the case where a top coat layer is formed, a material similar to the crystalline magnetic layer 53 is used for top coat layer. Specific examples include a material not containing oxide or lower in oxide content by 10% or more than the crystalline magnetic layer 53, a material higher in Cr content by 10% or more and lower in Pt content by 10% or more than the crystalline magnetic layer 53, and a material higher in Cr content by 10% or more than the crystalline magnetic layer 53.

The thicknesses of the crystalline magnetic layer and top coat layer are not particularly specified. For example, if the thickness of the crystalline magnetic layer is 15 nm and the thickness of the top coat layer is 5 nm, and the non-recording area is etched by 10 nm, the top coat layer is separated and the crystalline magnetic layer is etched by a thickness of 5 nm.

The resist 60 is used as a mask material for etching process of the magnetic recording layer 53 after transfer of patterns of protrusions and recesses by the following imprinting. The material of the resist is any material capable of transferring patterns by imprinting after coating, and including polymer material, low molecular weight organic material, and liquid Si resist. In the embodiment, spin-on-glass (SOG) is used, which is a kind of liquid Si resist.

As shown in FIG. 8B, patterns of protrusions and recesses are transferred by imprinting. The transfer process is carried out by using an imprinting apparatus of both-side simultaneous transfer type. On the entire surface of the resist (SOG) applied to both sides of the substrate, an imprint stamper (not shown) having formed thereon desired patterns of protrusions and recesses is pressed uniformly, thereby transferring patterns of protrusions and recesses on the surface of the resist 60. The recesses of the resist 60 formed in the transfer process corresponds to the recesses in the non-recording areas.

As shown in FIG. 8C, the crystalline magnetic layer 53 is processed. The crystalline magnetic layer 53 is exposed by etching the resist residue left in the recesses of the resist 60 having the patterns of protrusions and recesses obtained in FIG. 8B. Using the remaining patterned resist 60 as the mask, recesses are formed in the crystalline magnetic layer 53 by ion milling.

As shown in FIG. 8D, the crystalline magnetic layer 53 remaining in the bottoms of the recesses in the non-recording areas is made amorphous to form an amorphous damaged layer 55. In this process, preferably, Ar ions are implanted at an acceleration voltage of 10 keV to 1 MeV. It may be also realized by acceleration ion exposure, and even if the energy is insufficient by ion implantation, it is permissible as long as the crystalline magnetic layer in the non-recording areas can be heated. Alternatively, chemical processing using gas containing O₂, N₂, CF₄, SF₆, or other chemical materials may be applied.

As shown in FIG. 8E, the resist 60 remaining in the recording areas is removed by etching.

As shown in FIG. 8F, a protective layer 57 is formed on the surface. The protective layer prevents corrosion of the perpendicular recording layer, and also prevents damage of the medium surface when brought into contact with the magnetic head. The protective layer is made of material containing carbon (C) such as DLC, SiO₂, or ZrO₂. Further, a lubricant is applied to the surface.

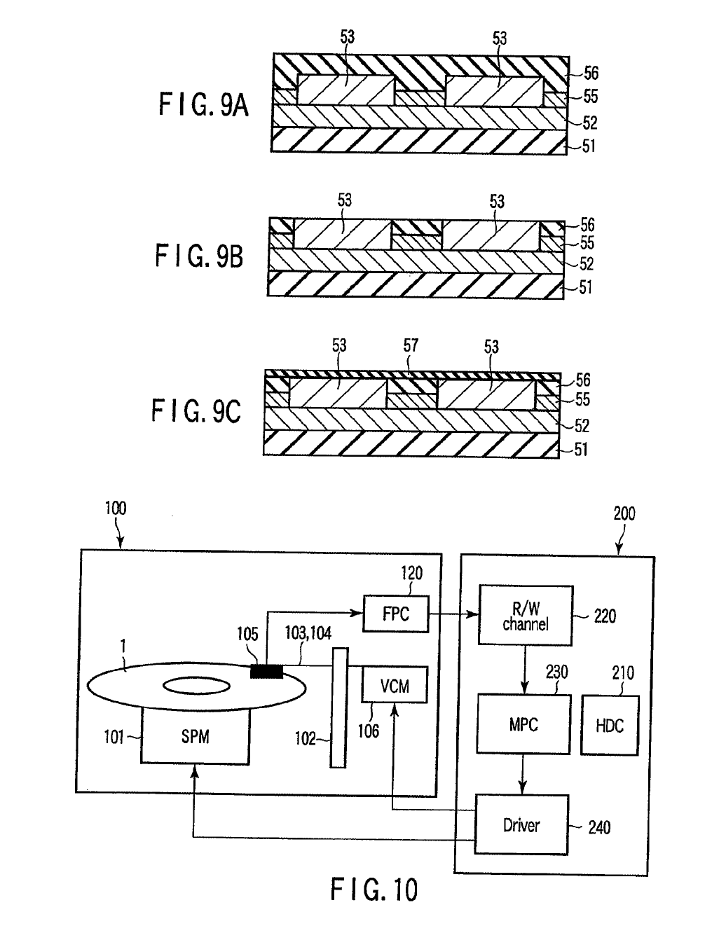

In the present invention, when filling the recesses above the amorphous damaged layer 55 with the embedding layer 56, a method as shown in FIGS. 9A to 9C may be employed. Prior to FIG. 9A, the processes from FIGS. 8A to 8E should be completed.

As shown in FIG. 9A, an embedding layer 56 of a sufficient thickness is deposited by sputtering. The embedding layer 56 may be formed of any material as long as it is not ferromagnetic, and preferred examples include carbon, SiO₂, Al₂O₃, and other oxides, Ti, Cr, Ni, Mo, Ta, Al, Ru, and other metals or their alloys or compounds. As shown in FIG. 9B, the embedding layer 56 is etched back until the surface of the crystalline magnetic layer 53 is exposed, the embedding layer 56 is buried into the recesses of the non-recording areas, and the surface is flattened. Further, as shown in FIG. 9C, a protective layer 57 is formed on the surface.

Now, description will be given of a magnetic recording apparatus in which the magnetic recording medium according to the present invention is mounted. FIG. 10 shows a block diagram of a magnetic recording apparatus according to an embodiment of the present invention. The figure shows a head slider only over a top surface of the magnetic recording medium. However, a perpendicular magnetic recording layer having discrete tracks is formed on both sides of the magnetic recording medium. A down head and an up head are provided over the top surface of and under the bottom surface of the magnetic recording medium, respectively. The configuration of the magnetic recording apparatus is basically similar to that of the conventional magnetic recording apparatus except that the former uses the magnetic recording medium according to the present invention.

A disk drive includes a main body portion called a head disk assembly (HDA) 100 and a printed circuit board (PCB) 200.

The head disk assembly (HDA) 100 has a magnetic recording medium (DTR medium) 1, a spindle motor 101 that rotates the magnetic recording medium 1, an actuator arm 103 that moves around a pivot 102, a suspension 104 attached to a tip of the actuator arm 103, a head slider 105 supported by the suspension 104 and including a read head and a write head, a voice coil motor (VCM) 106 that drives the actuator arm 103, and a head amplifier (not shown) that amplifies input signals to and output signals from the head. The head amplifier (HIC) is provided on the actuator arm 103 and connected to the printed circuit board (PCB) 200 via a flexible cable (FPC) 120. Providing the head amplifier (HIC) on the actuator arm 103 as described above enables an effective reduction in noise in head signals. However, the head amplifier (HIC) may be fixed to the HDA main body.

The perpendicular magnetic recording layer is formed on both sides of the magnetic recording medium 1 as described above. On each of the opposite perpendicular magnetic recording layers, the servo regions are formed like circular arcs so as to coincide with the locus along which the head moves. Specifications for the magnetic recording medium satisfy an outer diameter, an inner diameter, and read/write properties which are adapted for the drive. The radius of the circular arc formed by the servo region is given as the distance from the pivot to the magnetic head element.

Four main system LSIs are mounted on the printed circuit board (PCB) 200. The four main system LSIs include a disk controller (HDC) 210, a read/write channel IC 220, MPU 230, and a motor driver IC 240.

MPU 230 is a control section for a driving system and includes ROM, RAM, CPU, and a logic processing section which are required to implement a head positioning control system according to the present embodiment. The logic processing section is an arithmetic processing section composed of a hardware circuit to execute high-speed arithmetic processes. The firmware (FW) for the logic processing section is stored in ROM. MPU controls the drive in accordance with FW.

The disk controller (HDC) 210 is an interface section in the hard disk and exchanges information with an interface between the disk drive and a host system (for example, a personal computer), MPU, the read/write channel IC, and the motor driver IC to control the entire drive.

The read/write channel IC 220 is a head signal processing section composed of a circuit which switches a channel to the head amplifier (HIC) and which processes read/write signals.

The motor driver IC 240 is a driver section for the voice coil motor (VCM) 77 and the spindle motor 72. The motor driver IC 240 controls the spindle motor 72 to a given rotation speed and provides a VCM manipulation variable from MPU 230 to VCM 77 as a current value to drive a head moving mechanism.

### EXAMPLES

### Example 1

The imprint stamper used was a 0.4 mm thick Ni stamper. This stamper has a specified pattern in a range between the innermost radius of 4.7 mm and the outermost radius of 9.7 mm as shown in FIG. 1. The track pitch was 100 nm. The depth of the recesses of the stamper was 50 nm.

The substrate was a troidal glass disk of 20.6 mm in diameter and 6 mm in inner diameter. As a soft magnetic underlayer, a film of FeCoV was deposited in a thickness of 100 nm. As a crystalline magnetic layer, a film of CoCrPt—SiO₂ was deposited in a thickness of 15 nm. As a top coat layer, a film of CoCrPt not containing SiO₂ was deposited in a thickness of 5 nm. As a resist, a film of SOG resist, which is a Si compound, was applied in a thickness of 70 nm by spin coating.

To the substrate coated with the resist, an imprint stamper was pressed for 1 minute at a pressure of 200 MPa under an atmospheric pressure and at ambient temperature, and patterns of protrusions and recesses of the imprint stamper were transferred on the surface of the resist layer. By this transfer process, recesses of the resist corresponding to the non-recording areas were formed. The depth of recesses of the resist was 50 nm, same as the depth of recesses of the imprint stamper.

The resultant resist pattern with protrusions and recessed was etched by using CF₄ gas, the resist residues remaining at the recesses were removed, and the surface of the crystalline magnetic layer in the non-recording areas was exposed. In this state, the SOG resist was left in the recording areas leaving the crystalline magnetic layer. Using this SOG resist as the mask, the non-recording area was etched by 10 nm by Ar ion milling, and desired patterns of protrusions and recesses were obtained. By this milling, the top coat layer of the recording areas was separated, the crystalline magnetic layer in the non-recording areas was remove by 5 nm out of the total of 15 nm, and a crystalline magnetic layer of 10 nm was left in the bottoms of the recesses.

Next, by implanting Ar ions at acceleration energy of 100 keV, the crystalline magnetic layer left in the recesses was made amorphous to form an amorphous damaged layer.

At this moment, a part of the samples was taken out, and the recording area thereof was observed with a sectional TEM. As a result, a crystal lattice was observed in the crystalline magnetic layer in the recording areas, indicating that the crystalline state was maintained. On the other hand, in the magnetic layer in the non-recording areas, no crystal lattice was found, and amorphous state was confirmed. The brightness of the sectional TEM image was examined, with the result that the crystalline magnetic layer was dark, and the magnetic layer in the non-recording areas was brighter than the crystalline magnetic layer.

The residual SOG resist was removed by CF₄ gas etching. Finally, a DLC protective layer was formed on the surface of the magnetic recording medium, and a lubricant was applied, thereby manufacturing a DTR medium.

### Example 2

A DTR medium was manufactured in the same procedure as in example 1, except that NiTa alloy was used as an embedding layer, and filled in the recesses in the non-recording areas by sputtering by 50 nm after removing the resist, and was etched back to flatten the surface until the crystalline magnetic layer was exposed. The height difference on the surface after flattening was 5 nm.

### Comparative Example 1

A modified type DTR medium was manufactured in the same procedure as in example 2, except that ions were implanted in the non-recording areas to modify the crystalline magnetic layer, without removing the crystalline magnetic layer in the non-recording areas by ion milling.

### Comparative Example 2

A partially-etched type DTR medium was manufactured in the same procedure as in example 1, except that the crystalline magnetic layer in the non-recording areas was partially etched by ion milling.

### Comparative Example 3

A totally-etched type DTR medium was manufactured in the same procedure as in example 2, except that the crystalline magnetic layer in the non-recording areas was totally etched by ion milling, and filling and flattening were performed.

The media of examples 1 and 2 and comparative examples 1 to 3 were mounted on a drive, and the signal-to-noise ratio of servo signals was measured, the bit error rate (BER) by random signal recording was measured, and a touch-down test was conducted in a reduced atmosphere. Results are shown in Table 1.

In the comparative example 1 of the modified type, the bit error rate was lowered. In the comparative example 2 of the partially-etched type, the signal-to-noise ratio of servo signal intensity was not ensured, and there was difficulty in positioning. In the comparative example 3 of the totally-etched type, the touch-down pressure was raised. The medium surface was observed, to find that there was a height difference of 15 nm on the surface, indicating difficulty in flattening.

In example 1, a height difference of 5 nm was found on the medium surface, but the touch-down pressure was 0.5 atm, and there was no serious problem. Example 2 was completely free from problems.

Thus, in examples 1 and 2, the servo signal intensity in read/write operations was high, the bit error rate was low, and flying stability of the read/write head was excellent.

TABLE 1

| | Preamble | | TD |
|---|---|---|---|
| | SNR | BER | pressure |
| Example 1 | high | −6.5 | 0.5 |
| Example 2 | high | −6.5 | 0.4 |
| Comparative | high | −5.0 | 0.4 |
| Example 1 | | | |
| (modified) | | | |
| Comparative | low | −6.5 | 0.4 |
| Example 2 | | | |
| (partially etched) | | | |
| Comparative | high | −6.5 | 0.7 |
| Example 3 | | | |
| (totally etched) | | | |

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method for manufacturing a magnetic recording medium comprising:
depositing a crystalline magnetic layer on a substrate;
selectively etching a part of the crystalline magnetic layer corresponding to non-recording areas to form recesses in the non-recording areas with a part of the crystalline magnetic layer left in bottoms of the recesses and to form protruded recording areas; and
causing damage to the crystalline magnetic layer left in the bottoms of the recesses in the non-recording areas to form an amorphous damaged layer.

2. The method according to claim 1, wherein the crystalline magnetic layer and a top coat layer are stacked on a substrate, the top coat layer is removed over its entire thickness and the crystalline magnetic layer is removed in part of its thickness in performing selective etching corresponding to the non-recording areas.

3. The method according to claim 1, further comprising filling a recess above the amorphous damaged layer with a nonmagnetic embedding layer.
